(19) United States
(12) Patent Application Publication
(10) Pub. No.: US 2015/0212700 A1
(43) Pub. Date: Jul. 30, 2015

(54) DASHBOARD WITH PANORAMIC DISPLAY OF ORDERED CONTENT

(71) Applicant: Microsoft Technology Licensing, LLC, Redmond, WA (US)

(72) Inventors: Anant Kartik Mithal, Sammamish, WA (US); John H. Howard, Sammamish, WA (US); Michael M. Santos, Seattle, WA (US); Julianne Prekaski, Seattle, WA (US); Kate M. Spengler, Kirkland, WA (US); Hans G. Have, Seattle, WA (US); Kevin M. Honeyman, Fargo, ND (US); Morten Holm-Petersen, Copenhagen (DK)

(21) Appl. No.: 14/166,045

(22) Filed: Jan. 28, 2014

(51) Int. Cl. G06F 3/0484; G06Q 10/00; G06F 3/0482

(52) U.S. Cl. CPC G06F 3/04842; G06F 3/0482; G06Q 10/00

(57) ABSTRACT

A role-based dashboard display is generated, showing a plurality of different display sections that display information from a computer system. The display sections include a customer-branded section, a favorites section, a workspace display section and a live data feed section. The sections have display elements linked to underlying data.

### BACKGROUND

Computer systems are very common today. In fact, they are in use in many different types of environments.

Some computer systems include business computer systems, which are also in wide use. Business systems include customer relations management (CRM) systems, enterprise resource planning (ERP) systems, line-of-business (LOB) systems, etc. These types of systems often include business data that is stored as entities or other business data records. Such business data records (or entities) often include records that are used to describe various aspects of a business. For instance, they can include customer entities that describe and identify customers, vendor entities that describe and identify vendors, sales entities that describe particular sales, quote entities, order entities, inventory entities, etc. The business systems also commonly include process functionality that facilitates performing various business processes or tasks on the data. Users log into the business system in order to perform business tasks for conducting the business.

Such business systems also currently include roles. Users are assigned one or more roles based upon the types of tasks they are to perform for the business. The roles can include certain security permissions, and they can also provide access to different types of data records (or entities), based upon a given role.

Business systems can also be very large. They contain a great number of data records (or entities) that can be displayed or manipulated through the use of thousands of different forms. Therefore, visualizing the data in a meaningful way can be very difficult. This problem is exacerbated when a user has one or more roles, or when a user has a given role that is responsible for a wide variety of different types of business tasks. It can be very cumbersome and time consuming for a user to navigate through various portions of a business system in order to view data or other information that is useful to that particular user, in that particular role.

The discussion above is merely provided for general background information and is not intended to be used as an aid in determining the scope of the claimed subject matter.

### SUMMARY

A role-based dashboard display is generated, showing a plurality of different display sections that display information from a computer system. The display sections include a customer-branded section, a favorites section, a workspace display section and a live data feed section. The sections have display elements linked to underlying data.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative business system.

FIG. 2 is a flow diagram illustrating one embodiment of the operation of the business system shown in FIG. 1 in generating and manipulating a dashboard display.

FIGS. 2A-2I show a plurality of different, illustrative, user interface displays.

FIG. 3 is a flow diagram illustrating one embodiment of the operation of the business system shown in FIG. 1 is facilitating user customization of a given workspace display element on the dashboard display.

FIG. 3A shows one exemplary user interface display.

FIG. 4 is block diagram showing the system of FIG. 1 is various architectures.

FIGS. 5-10 show different embodiments of mobile devices.

FIG. 11 is a block diagram of one illustrative computing environment.

### DETAILED DESCRIPTION

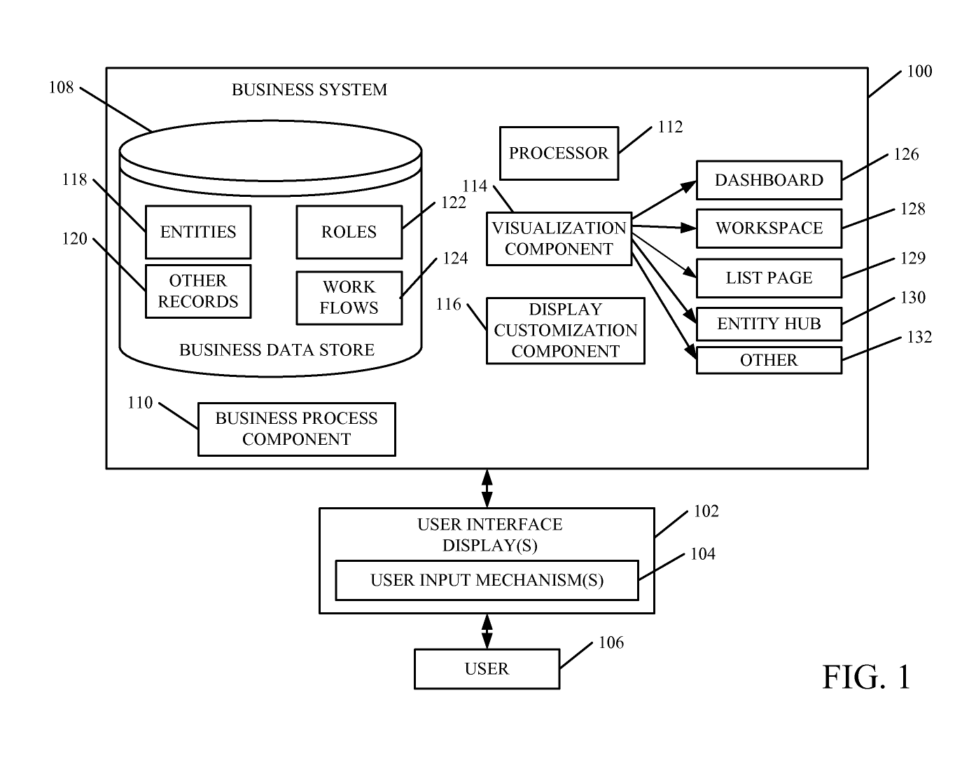

FIG. 1 is a block diagram of one embodiment of business system 100. Business system 100 generates user interface displays 102 with user input mechanisms 104 for interaction by user 106. User 106 illustratively interacts with the user input mechanisms 104 to control and manipulate business system 100. Business system 100 illustratively includes business data store 108, business process component 110, processor 112, visualization component 114 and display customization component 116. Business data store 108 illustratively includes business data for business system 100. The business data can include entities 118 or other types of business records 120. It also includes a set of roles 122 that can be held by various users of the business data system 100. Further, business data store 108 illustratively includes various workflows 124. Business process component 110 illustratively executes the workflows 124 on entities 118 or other business data records 120, based on user inputs from users that each have one or more given roles 122.

Visualization component 114 illustratively generates various visualizations, or views, of the data and processes (or workflows) stored in business data store 108. Visualizations can include, for example, one or more dashboard displays 126, a plurality of different workspace displays 128, a plurality of different list page displays 129, a plurality of different entity hub displays 130, and other displays 132.

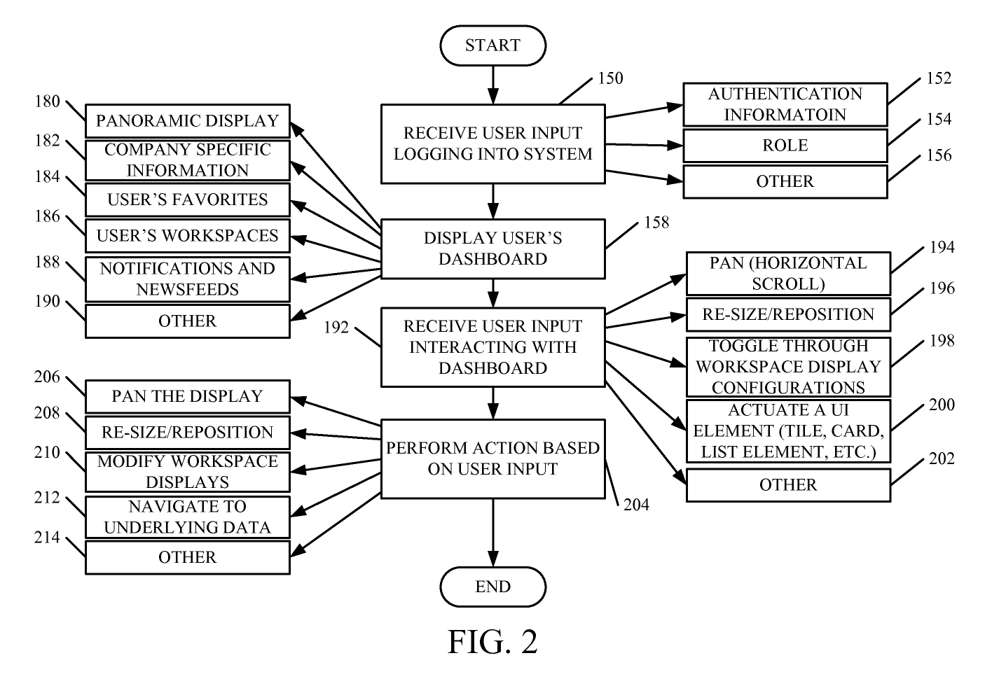

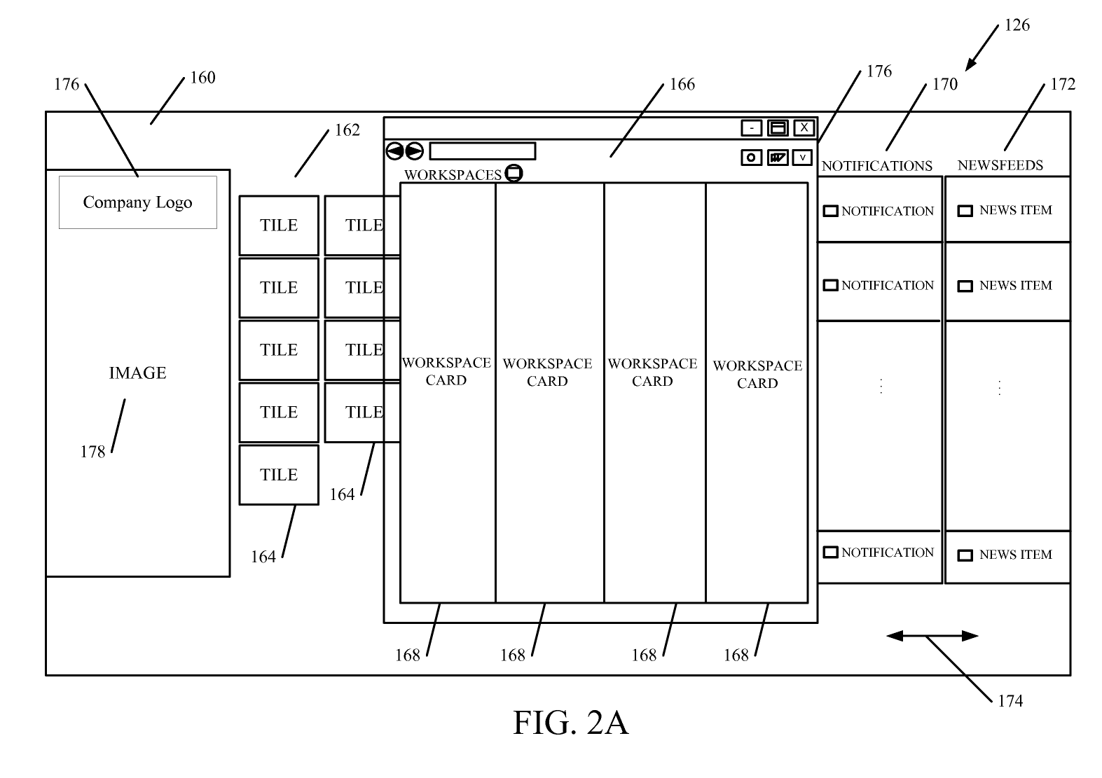

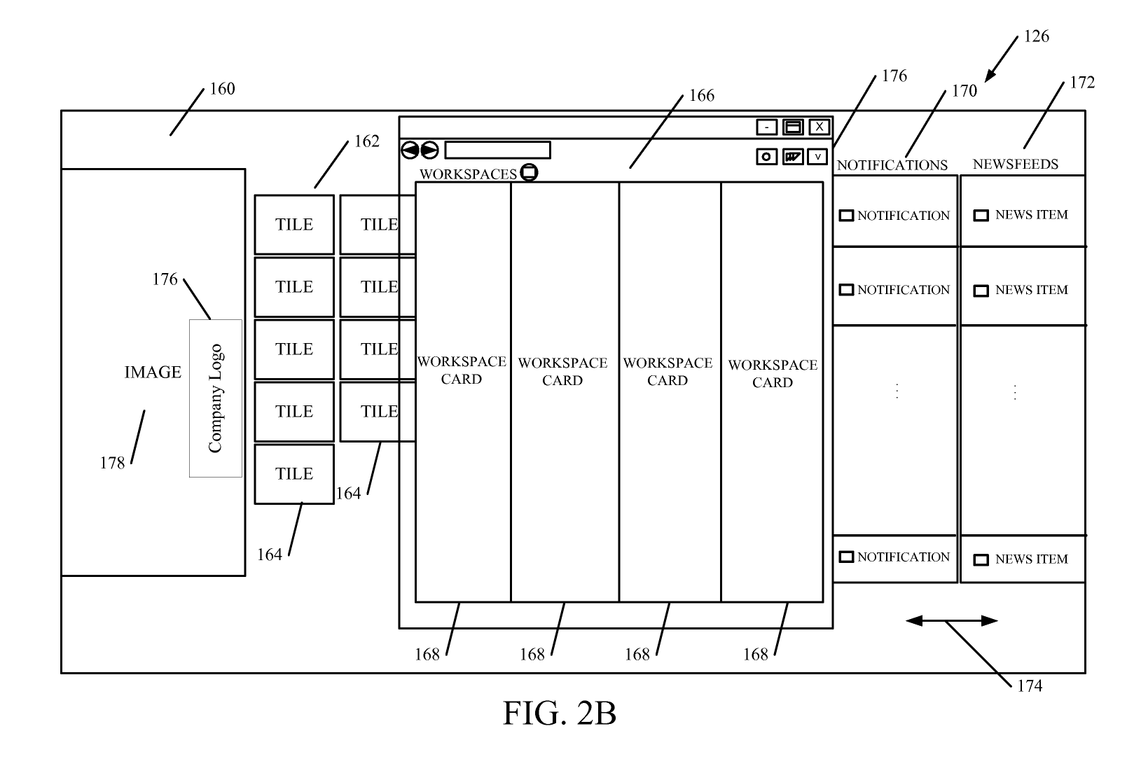

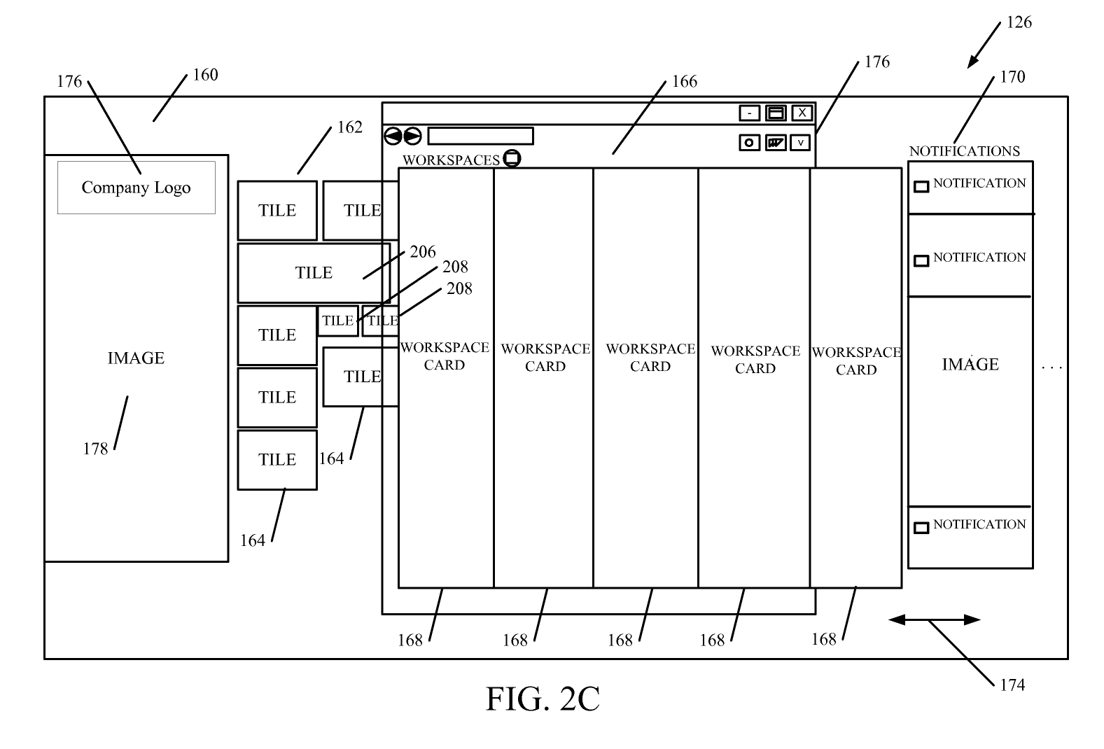

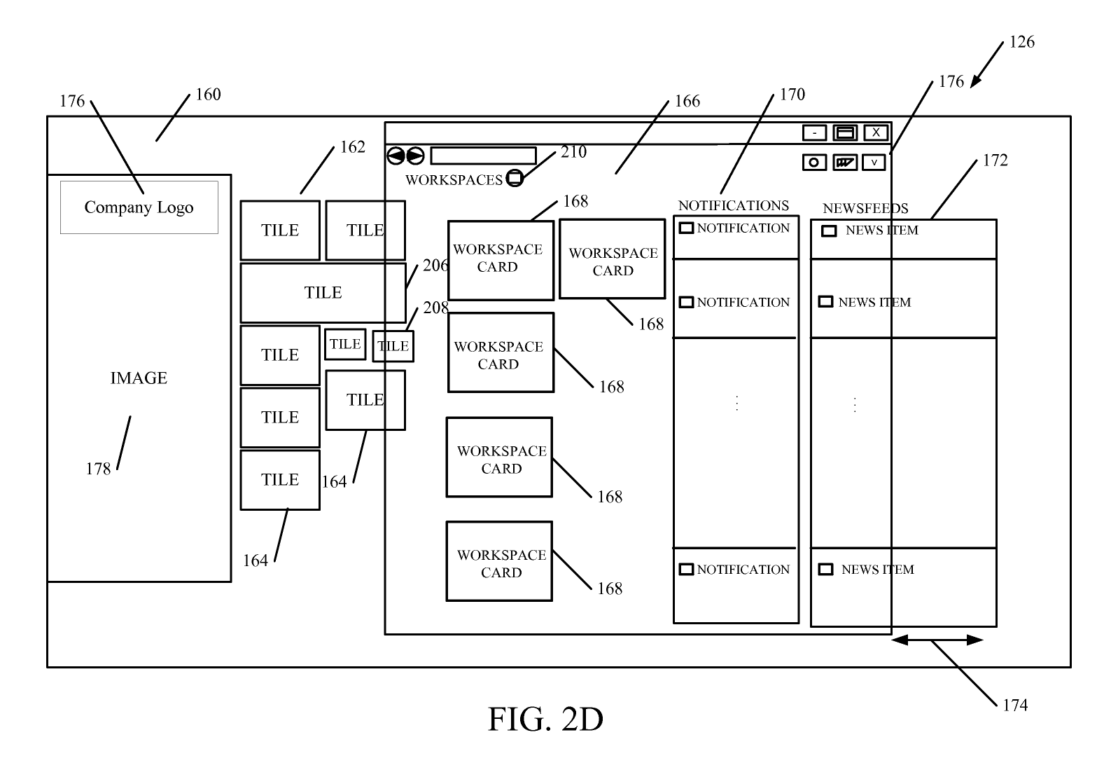

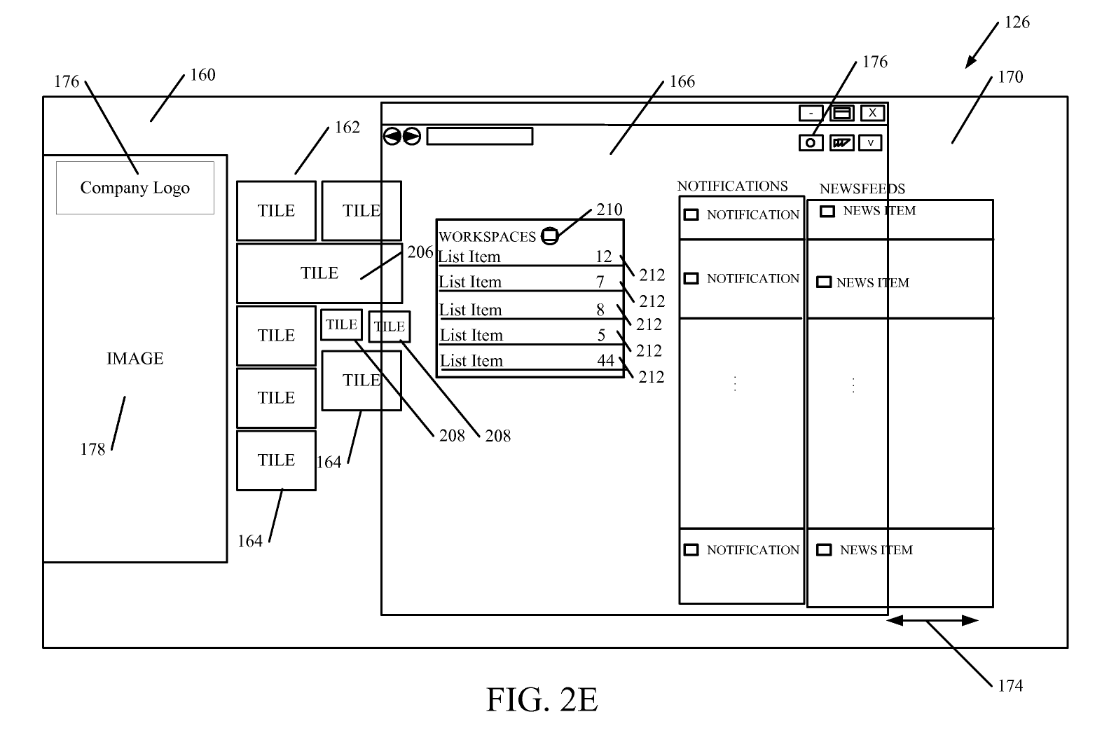

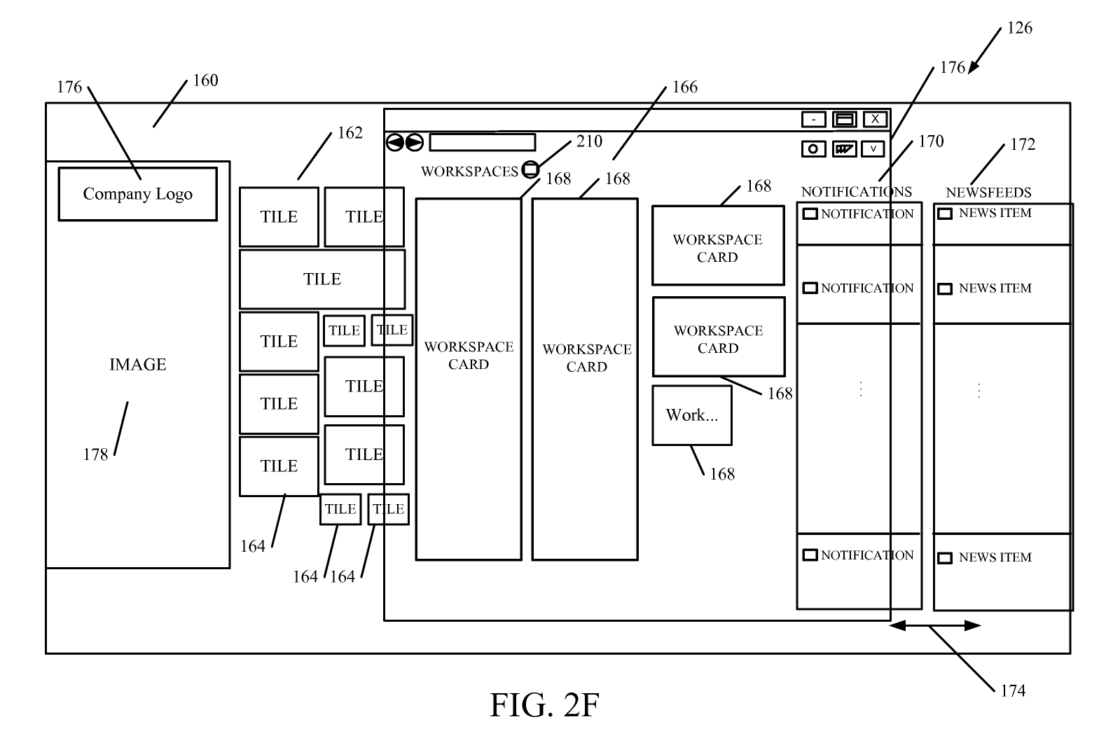

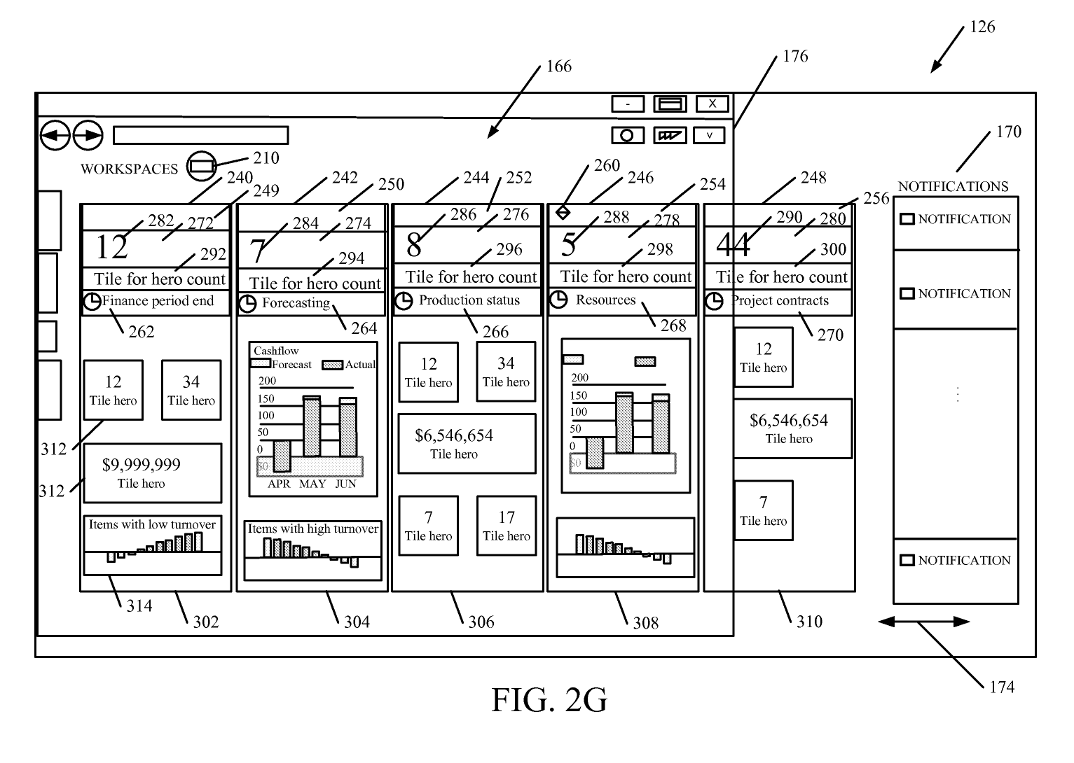

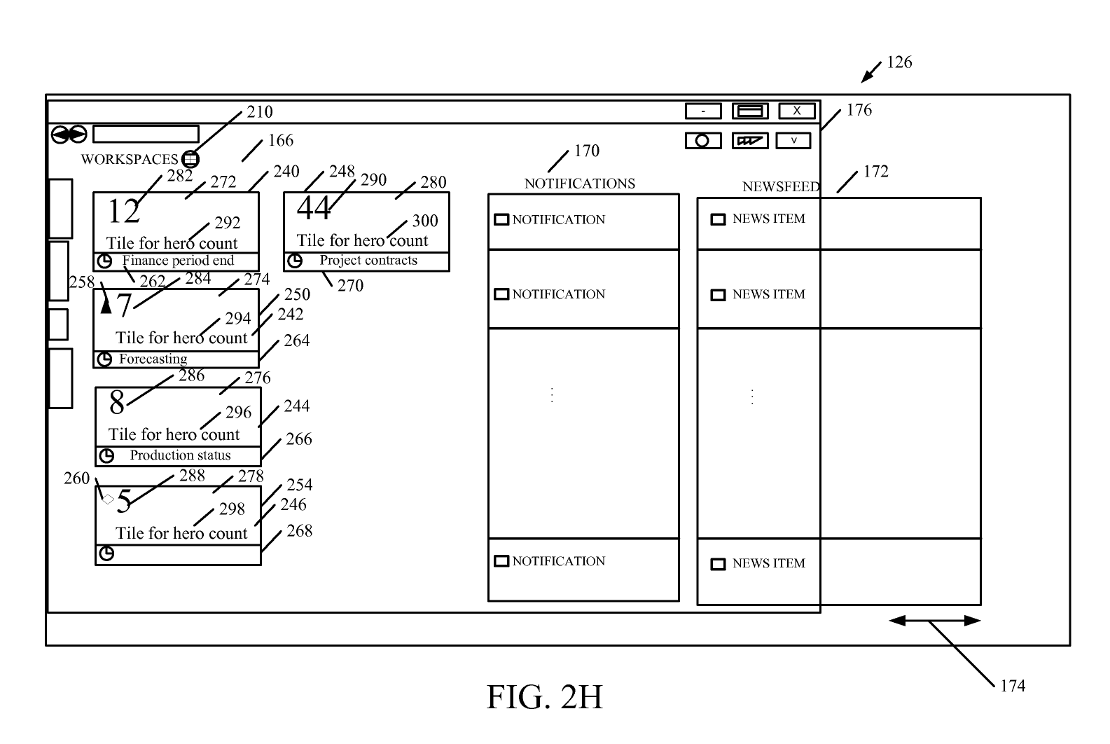

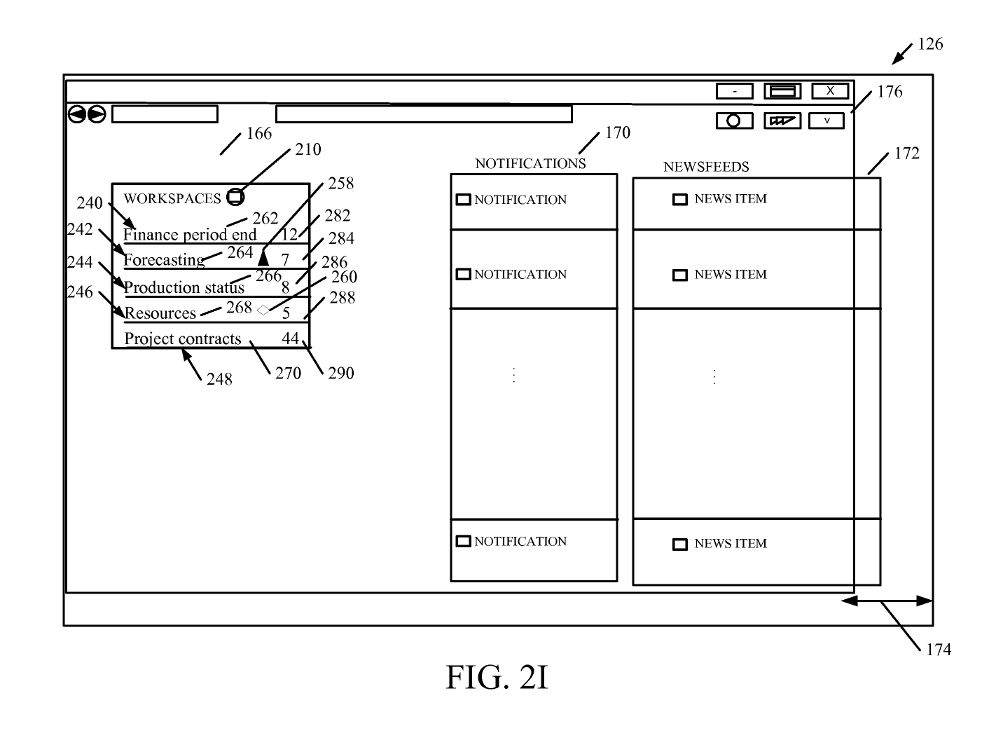

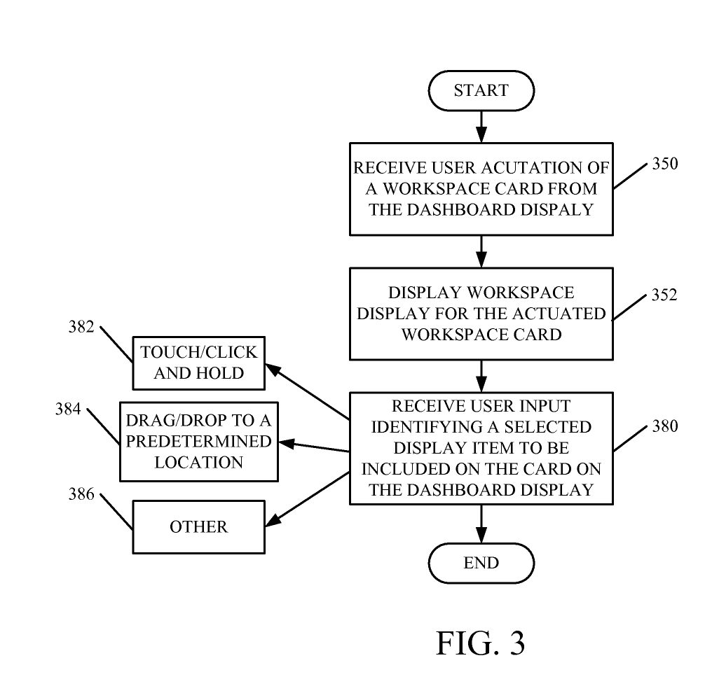

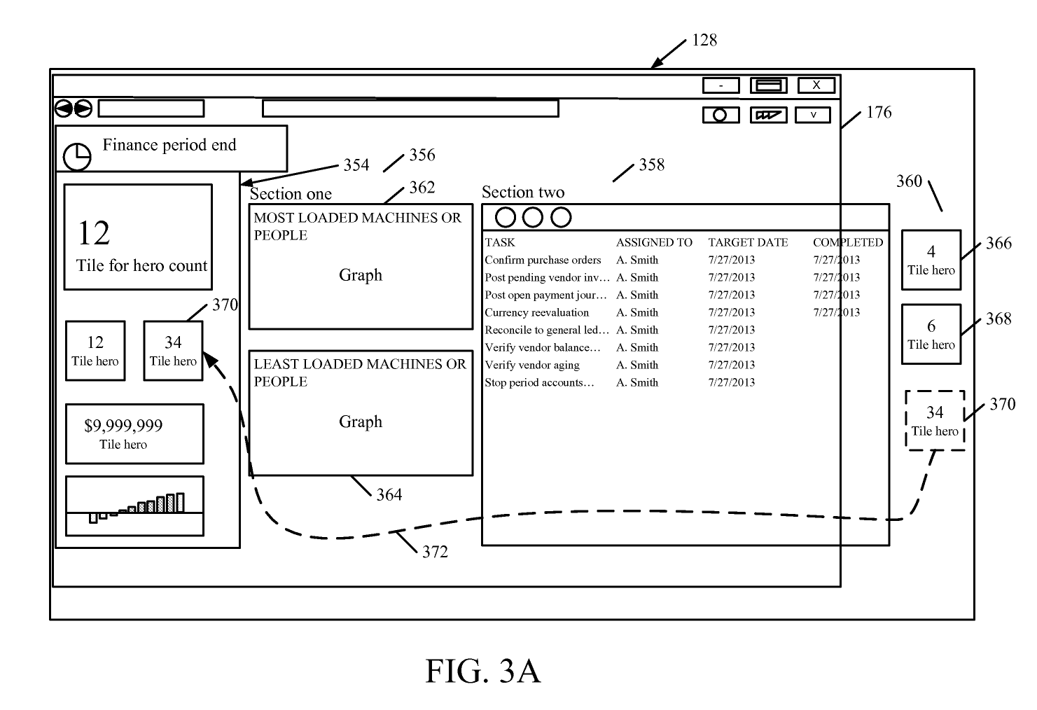

Dashboard display 126 is illustratively an overview of the various data and workflows in business system 100. It illustratively provides a plurality of different links to different places within the applications comprising business system 100. Dashboard display 126 illustratively includes a plurality of different display sections that each include a variety of different display elements. For instance, dashboard display 126 can include an end-customer-branded section that includes a customer logo, for instance, or other customer branding display elements. It can also include a workspace section that includes a combination of workspace display elements that can be manipulated by the user. Further, it can include a newsfeed and notification section that shows a running stream of information about work that the user has been assigned, or that the user wishes to be notified of, along with related company news (both internal and external) in a newsfeed. Dashboard display 126 can also present a highly personalized experience. Dashboard 126 is described in greater detail below with respect to FIGS. 2-3A.

Workspace display 128 is illustratively a customizable, activity-oriented display that provides user 106 with visibility into the different work (tasks, activities, data, etc.) performed by user 106 in executing his or her job. The workspace display 128 illustratively consolidates information from several different areas in business system 110 (e.g., in one or more business applications that execute the functionality of business system 100) and presents it in an organized way for visualization by user 106.

List page display 129 is illustratively a page that breaks related items out into their individual rows. Other displays 126, 128 and 130 illustratively have user actuable links that can summarize related information, but can be actuated to navigate the user to a list page display 129 that has the related information broken out. For example, whereas a workspace display 128 may have multiple individual elements (such as tiles or lists or charts, etc.) that summarize the related information, the corresponding list page 129 will break summarized information into their individual rows. A workspace display 128 can also have multiple elements that each point to a different list page display 129.

Entity hub display 130 is illustratively a display that shows a great deal of information about a single data record (such as a single entity 118 or other data record 120, which may be a vendor record, a customer record, an employee record, etc.). The entity hub display 130 illustratively includes a plurality of different sections of information, with each section designed to present its information in a given way (such as a data field, a list, etc.) given the different types of information.

Business process component 110 illustratively accesses and facilitates the functionality of the various workflows 124 that are performed in business system 100. It can access the various data (such as entities 118 and business records 120) stored in data store 108 in facilitating this functionality as well.

Display customization component 116 illustratively allows user 106 to customize the displays that user 106 has access to in business system 100. For instance, display customization component 116 can provide functionality that allows user 106 to customize the dashboard display 126 or one or more of the workspace displays 128 that user 106 has access to in system 100.

Processor 112 is illustratively a computer processor with associated memory and timing circuitry (not separately shown). It is illustratively a functional part of business system 100 and is activated by, and facilitates the functionality of, other components or items in business system 100.

Data store 108 is shown as a single data store, and is local to system 100. It should be noted, however, that it can be multiple different data stores as well. Also, one or more data stores can be remote from system 100, or local to system 100, or some can be local while others are remote.

User input mechanisms 104 can take a wide variety of different forms. For instance, they can be text boxes, active tiles that dynamically display parts of the underlying information, check boxes, icons, links, drop down menus, or other input mechanisms. In addition, they can be actuated by user 106 in a variety of different ways as well. For instance, they can be actuated using a point and click device (such as a mouse or trackball), using a soft or hard keyboard, a thumb pad, a keypad, various buttons, a joystick, etc. In addition, where the device on which the user interface displays are displayed has a touch sensitive screen, they can be actuated using touch gestures (such as with the user's finger, a stylus, etc.). Further, where the device or system includes speech recognition components, they can be actuated using voice commands.

It will also be noted that multiple blocks are shown in FIG. 1, each corresponding to a portion of a given component or functionality performed in system 100. The functionality can be divided into additional blocks or consolidated into fewer blocks. All of these arrangements are contemplated herein.

In one embodiment, each user 106 is assigned a role 122, based upon the types of activities or tasks that the given user 106 will perform in business system 100. Thus, in one embodiment, dashboard display 126 is generated to provide information related to the role of a given user 106. That is, user 106 is provided with different information on a corresponding dashboard display 126, based upon the particular role or roles that are assigned to user 106 in business system 100. In this way, user 106 is presented with a visualization of information that is highly relevant to the job being performed by user 106 in business system 100.

In addition, some types of roles 122 may have multiple corresponding workspace displays 128 generated for them. By way of example, assume that user 106 is assigned an administrator's role in business system 100. In that case, user 106 may be provided with access to multiple different workspace displays 128. A workspace display 128 may show information for a security workspace. The security workspace may include information related to security features of business system 100, such as access, permissions granted in system 100, security violations in system 100, authentication issues related to system 100, etc. User 106 (being in an administrative role) may also have access to a workspace display 128 corresponding to a workspace that includes information about the health of system 100. This workspace display 128 may include information related to the performance of system 100, the memory usage and speed of system 100, etc. Thus, a given user 106 that has only a single role 122 may have access to multiple different workspace displays 128.

Similarly, a given user 106 may have multiple different roles 122. By way of example, assume that a given user 106 is responsible for both the human resources tasks related to business system 100, and the payroll tasks. In that case, the given user 106 may have a human resources role 122 and a payroll role 122. Thus, user 106 may have access to one or more workspace displays 128 for each role 122 assigned to user 106 in business system 100. In this way, when user 106 is performing the human resources tasks, user 106 can access the human resources workspace display 128, through dashboard display 126, which will contain a set of information that user 106 believes is relevant to the human resources role and the human resources tasks. Then, when user 106 is performing the payroll tasks in system 100, user 106 can access one or more payroll workspace displays 128, through dashboard 126, which contain the information that user 106 believes is relevant to the payroll tasks and role. Is this way, the user need not have just a single display with all the information related to both the payroll tasks and the human resources tasks combined, which can be confusing and cumbersome to work with. Instead, the user 106 can illustratively have workspace display elements on the dashboard display 126, each workspace display elements corresponding to a different workspace display. When the user actuates one of the workspace display elements, the user can then be navigated to the corresponding workspace display 128.

FIG. 2 is a flow diagram illustrating one embodiment of the operation of system 100 in generating and manipulating dashboard display 126. Visualization component 114 first generates a user interface displays that allows the user the log into business system 100 (or otherwise access business system 100) and request access to a dashboard display 126 corresponding to the role or roles assigned to user 106. Generating the UI display to receive a user input requesting a dashboard display is indicated by block 150 in FIG. 2.

This can include a wide variety of different things. For instance, user 106 can provide authentication information 152 (such as a username and password) or a role 154 (or the role can be automatically accessed within system 100 once the user provides authentication information 152). In addition, user 106 can provide other information 156 as well.

In response, visualization component 114 illustratively generates a dashboard display 126 that is specific to the given user 106, having the assigned role. Displaying the user's dashboard display 126 is indicated by block 158 in FIG. 2.

FIG. 2A shows one embodiment of a user interface display illustrating a dashboard display 126. Dashboard display 126 illustratively includes a plurality of different display section. For instance, in one embodiment, dashboard display 126 includes an end-user branding section 160, which displays company or organization-specific information corresponding to the company or organization that is deploying business system 100. Dashboard display 126 also illustratively includes a favorites section 162 which includes a plurality of different display elements 164, each of which dynamically display information corresponding to underlying data or processes selected by the user to appear in section 162. If the user actuates one of display elements 164, the user is illustratively navigated to a more detailed display corresponding to the particular data or process represented by the actuated display element.

Dashboard display 126 also illustratively includes a workspace display section 166 that includes a plurality of workspace display elements 168. Each workspace display element 168 illustratively represents a different workspace display that, itself, shows information for a workspace in the business system 100 that is relevant to user 106. As will be described below with respect to FIGS. 2D-2I, the particular visual representation of the workspace display elements 168 that is shown on dashboard display 126 can be modified by the user.

Dashboard display 126 also illustratively includes a notifications section 170 and a newsfeed section 172. It will be noted that sections 170 and 172 can be either separate sections, or combined into a single section. In one embodiment, notifications section 170 illustratively includes a set of notification elements each corresponding to a notification that can be customized by user 106. Therefore, user 106 can add items that the user wishes to be notified of, into section 170. Newsfeed section 172 illustratively includes links to news from a plurality of different sources. The sources can be multiple internal sources, or external sources, or a combination of internal and external sources. For instance, the newsfeed section 172 can include links to news on a social network, on an internal company network, news identified from external news sites, etc. In one embodiment, when the user actuates one of the newsfeed items in section 172, the user is navigated to the underlying news story.

FIG. 2A also shows that, in one embodiment, dashboard display 126 is a panoramic display, in that it can be scrolled horizontally in the direction indicated by arrow 174. FIG. 2A shows one embodiment of computer display screen 176. Thus, it can be seen that, in FIG. 2A, sections 160 and 162 are off the screen to the left. If the user scrolls panoramic display 126 in that direction, the user can view sections 160 and 162, and at least a portion of section 166 will be scrolled off the screen to the right. By contrast, FIG. 2A shows that sections 170 and 172 are off the screen to the right. If the user scrolls display 126 in that direction, then the user can see sections 170 and 172, and at least a portion of section 166 will scroll off the screen to the left.

In one embodiment, the initial display of dashboard display 126 can be dynamic. For instance, when the user first requests access to dashboard display 126, visualization component 114 can begin by displaying section 160. Thus, the user can see a company logo display 176, one or more different images 178, or a variety of other end-customer branding information, or even personalized information, such as the user's name, the user's role or roles, along with the date, time, or other information. However, as visualization component 114 loads data into dashboard display 126 (after several seconds, for instance), visualization component 114 can illustratively change the display, such as by pushing sections 160 and 162 off the screen to the left, and stop on workplace display section 166. Thus, once visualization component 114 has loaded all of the data into dashboard display 126, the final landing page for user 106 may or may not be section 160. For instance, workspace display section 166 can be the first fully-viewable section that is presented to the user at rest-loading. In one embodiment, the user can adjust the final landing page so that the particular sections of dashboard display 126 that are shown on display screen 176, once dashboard display 126 is fully loaded, can be selected by the user. In another embodiment, the final landing page display is predetermined.

FIG. 2B is similar to FIG. 2A, and similar items are similarly numbered. However, FIG. 2B illustrates that the end-customer branding information displayed in section 160 can take a wide variety of different forms. For instance, branded information 176 can be displayed in a variety of different orientations. In FIG. 2A it is shown in a generally horizontal orientation at the top of the display. In FIG. 2B, it is shown in a generally vertical orientation on the right side of the display. It can be displayed in other ways as well, such as by actively scrolling the information across the screen, by displaying it in any position, in substantially any size, using a static or dynamic display, or in other ways as well.

Referring again to the flow diagram of FIG. 2, displaying the dashboard display 126 as a panoramic (horizontally scrollable) display is indicated by block 180. Displaying company specific information in section 160 is indicated by block 182. Displaying user favorite information in section 162 is indicated by block 184. Displaying user workspace display elements (e.g., cards) in section 166 is indicated by block 186, and displaying notifications and newsfeeds either in separate sections 170 and 172, or in a combined section, is indicated by block 188. Of course, the dashboard display 126 can include other information 190 as well.

Visualization component 114 then illustratively receives a user input indicating a user interaction with some portion of dashboard display 126. This is indicated by block 192 in the flow diagram of FIG. 2. User 106 can provide a wide variety of user inputs to interact with dashboard display 126. For instance, user 106 can pan (e.g., horizontally scroll) display 126 in the directions indicated by arrow 174. This is indicated by block 194 in FIG. 2. The user can also illustratively resize or reposition various display elements in sections 160. This is indicated by block 196 in FIG. 2. The user 106 can also illustratively toggle through different visual representations of the workspace display elements. This is described in greater detail below with respect to FIGS. 2D-2I, and is indicated by block 198 in FIG. 2. In addition, user 106 can illustratively actuate one of the user interface display elements on dashboard display 126, in order to navigate to a more detailed display of the underlying information. This is indicated by block 200 in FIG. 2. The user can provide other inputs to interact with display 126 as well, and this is indicated by block 202 in FIG. 2.

Once the user has provided an input to interact with display 126, visualization component 114 illustratively performs an action based on the user input. This is indicated by block 204 in FIG. 2. The action performed by visualization component 114 will vary, based upon the particular user interaction. For instance, if the user interacts with display 126 to pan the display, then visualization component 114 will control display 126 to pan it to the right or to the left. This is indicated by block 206. If the user provides an interaction to resize or reposition a display element on display 126, then visualization component 114 illustratively resizes or repositions that element. This is indicated by block 208. If the user provides an input to toggle through the various visual representations of the workspace display elements 168, then visualization component 114 toggles through those visual representations. This is indicated by block 210. If the user actuates one of the user interface display elements on dashboard display 126, then visualization component 114 illustratively navigates the user to a more detailed display of the corresponding information. This is indicated by block 212. If the user interacts with dashboard display 126 in other ways, then visualization component 114 performs other actions. This is indicated by block 214.

It should also be noted that the particular items displayed in each of sections 160, 162, 166, 170 and 172 can be customized as well. For instance, in one embodiment, user 106 can navigate to a specific place in the application or applications which are run in business system 100 and “pin” or otherwise select items to be displayed as the user interface elements in each of the sections on dashboard 126. Modifying the particular elements displayed on each individual workspace display element 168 is described in more detail below with respect to FIGS. 3 and 3A.

FIGS. 2C-2I show various user interface displays indicating some of the user interactions with dashboard display 126, and the corresponding actions performed by visualization component 114. FIG. 2C shows another embodiment of dashboard display 126. A number of the items shown in FIG. 2C are similar to those shown in FIGS. 2A and 2B, and are similarly numbered. However, FIG. 2C shows that a number of the user interface display elements in favorites section 162 have been rearranged or resized. For instance, user interface display element 206 has been enlarged. User 106 can resize user interface display elements in a variety of different ways. In one embodiment, user 106 touches and holds (or clicks on) a user interface display element such as display element 206 to select it. The user can resize it using touch gestures, point and click inputs, or other user inputs. Similarly, user 106 can reposition user interface elements by selecting them, and then providing a suitable user input in order to move the user interface display element on dashboard 126. It can be seen in FIG. 2C that display element 206 has been enlarged, while display elements 208 have been reduced in size.

FIG. 2C also shows that workspace section 166 illustratively includes a workspace representation element 210. Element 210 is illustratively actuatable by user 106. When user 106 actuates element 210, visualization component 114 illustratively changes the visual representation of the workspace display elements (or display cards) 168. In one embodiment, user 106 can actuate element 210 a plurality of different times, to toggle through a plurality of different visual representations for workspace display cards 168 in section 166. A number of those visual representations will now be described.

By way of example, assume that display screen 176 is a touch sensitive display screen. Then, if user 106 touches item 210, visualization component 114 toggles through the visual representations of workplace display cards 168 to a next visual representation. FIG. 2D illustrates this. It can be seen that FIG. 2D is similar to FIG. 2C, and similar items are similarly numbered. However, FIG. 2D shows that the visual representations of workspace display cards 168 are now smaller representations. In one embodiment, the amount of data displayed on cards 168 is modified for the reduction in size. For instance, the amount of data displayed on cards 168 can be reduced. In another embodiment, the amount of data is the same, but the size of the data displayed on cards 168 is reduced. Of course, the data displayed on cards 168 can be modified in other ways as well.

FIG. 2D also shows that the number of sections from dashboard display 126 that are now displayed on display screen 176 has increased. It can be seen that notifications section 170 and a portion of newsfeed section 172, are now displayed on display screen 176, along with the entire workspace display section 166.

In one embodiment, user 106 can again actuate item 210 to toggle to yet a different visual representation of workspace display cards 168. For instance, if user 106 toggles item 210 again, the user interface display elements corresponding to each of the workspaces can be displayed as list items within a list. FIG. 2E shows one embodiment of this.

In the user interface display shown in FIG. 2E, those items that are similar to items 2D are similarly numbered. However, it can be seen that workspace display section 166 now displays a list with a set of list items 212. One list item 212 corresponds to each of the workspaces previously represented (in FIG. 2D) by a workspace display card 168. Because workspace display section 166 is now a list, even more information from newsfeed section 172 is displayed on display screen 176.

In another embodiment, user 106 can toggle item 210 to have visualization component 114 display the user interface display elements in section 166 in yet a different representation. FIG. 2F shows one embodiment of this. In FIG. 2F, it can be seen that user 106 has customized the representations for the various workspace display cards 168. Two of the workspace display cards are in the larger representation, two are in a medium representation (also shown in FIG. 2D) and one is in a small representation. In one embodiment, user 106 can customize user interface display elements 166 in this way, and workspace display section 166 will always be displayed in the customized representation. However, in another embodiment, the customized representation shown in FIG. 2F is simply one of the visual representations that visualization component 114 will generate, as the user toggles through the plurality of different visual representations using item 210. All of these embodiments are contemplated herein.

Also, while a number of visual representations have been discussed, others can be displayed as well. For instance, all workspace display cards 168 can be displayed in small representations or in other representations.

FIGS. 2G-2I show portions of a dashboard display 126 to illustrate various features of workspace display section 166 in more detail. FIG. 2G shows a plurality of workspace display cards 240, 242, 244, 246 and 248. The display cards have a plurality of different types of information. Each display card illustratively has an alerts section 249-256, respectively. The alerts section illustratively displays alerts or messages or other information that the user has selected to show in that section. For instance, alerts section 250 includes an alert indicator 258 that shows user 106 that an alert has been generated in the workspace corresponding to workspace display card 242. Similarly, section 254 includes a user interface display element 260 that indicates that an item of interest is generated in the workspace corresponding to workspace display card 246. Each of the display cards also includes a title section 262-270, respectively. The title sections 262-270 illustratively display the title of the corresponding workspace. Each workspace display card 240-248 also illustratively includes a hero counts section 272-280, respectively. Sections 272-280 illustratively display a count or a numerical indicator corresponding to a business metric or other count item selected by user 106 to appear in that section, for that workspace. Each count section 272-280 illustratively includes a numerical indicator 282-290, respectively, along with a count title section 292-300, respectively. The count title section 292-300 identifies the title of the business metric or other numerical item that is reflected by the numerical indicator 284-290, respectively.

Each workspace display card 240-248 also includes an additional information section 302-310, respectively. The particular visual display elements displayed on additional information sections 302-310 can vary widely. They are also illustratively selectively placed there by user 106. By way of example, the display elements can include active or dynamic tiles, lists, activity feeds, charts, quick links, images, label/value pairs, calendars, maps, other cards, or other information. By way of example, additional information section 302 in card 240 illustratively includes three different tiles 312, two of which are sized in a relatively small size and one of which is relatively larger. Each tile 312 is illustratively a dynamic tile so that it displays information corresponding to underlying data or process. As the underlying data or process changes, the information on the dynamic tile 312 changes as well.

Additional information section 302 also illustratively includes a chart 314. Again, the chart is illustratively dynamic so as the underlying data which it represents changes, the display of chart 314 changes as well. In addition, each of the display elements 312-314 in section 302, can be user actuatable display elements. Therefore, when the user actuates one of those elements (such as by tapping it or clicking on it), visualization component 114 navigates the user to a more detailed display of the underlying information or process. In one example, the entire workspace display card is a user actuatable element as well. Therefore, if the user actuates it (such as by tapping it or by clicking on it) anywhere on the display card, the user is navigated to a more detailed display of the actual workspace that is represented by the corresponding workspace display card. This is described in greater detail below with respect to FIGS. 3 and 3A.

FIGS. 2H and 2I show more detailed embodiments illustrating exemplary displays that are shown when the user actuates item 210, to toggle through the various visual representations of the workspace display cards. For instance, when the user is viewing the dashboard display 126 shown in FIG. 2G, and actuates item 210, visualization component 114 illustratively modifies the visual representation of workspace display cards 240-248 to an intermediate version, such as that shown in FIG. 2H.

FIG. 2H shows an embodiment in which the amount of information displayed on the workspace display cards 240-248 is reduced in order to accommodate the smaller size of the display cards 240-248. For instance, it can be seen that the display cards 240-248 include count sections 272-280, along with the numerical indicators 282-290, and the corresponding titles 292-300. In addition, the workspace display cards 240-248 in FIG. 2H include the workspace title sections 262-270, and the alert or notifications 258 and 260. Again, in the display shown in FIG. 2H, each of the workspace display cards 240-248 are user actuatable items. When the user actuates one of them (such as by tapping on it or by clicking on it), visualization component 114 illustratively navigates the user to a workspace display for the corresponding workspace. The user 106 can also again actuate item 210 in order to change the visual representation of the workspace display cards in section 166, to a different visual representation.

FIG. 2I shows one embodiment in which the workspace display elements in section 166 have been changed to list items 240-248. Each list item 240-248 corresponds to one of the workspace display cards 240-248 displayed above in FIGS. 2G and 2H and they are similarly numbered. Because workspace display section 166 has now been reduced to a list of items, again the amount of information corresponding to each of the workspaces has been reduced. However, it can be seen in FIG. 2I that the amount of information displayed in the list in section 166 is the same as that for the workspace display cards shown in FIG. 2H, except that the title sections 292-300, for the particular numerical indicators 282-290, is not shown in FIG. 2I. Other than that, all of the same information is shown (albeit in list form) as illustrated in FIG. 2H. Again, in one embodiment, each of the list items 240-248 shown in FIG. 2I are user actuatable items. When the user actuates any of those list items, visualization component 114 illustratively navigates the user to the underlying workspace display.

In one embodiment, the particular information that shows up on the various visual representations of workspace display elements shown in section 166 on dashboard display 126 can be customized by user 106. That is, user 106 can select items that will be displayed on the various visual representations of the workspace display cards and list items discussed above. FIGS. 3 and 3A illustrate one embodiment of this.

FIG. 3 is a flow diagram illustrating one embodiment of the operation of customization component 116 (shown in FIG. 1) in allowing user 106 to customize the particular workspace display elements 166 that are displayed on dashboard 126. FIG. 3A is one exemplary user interface display that illustrates this as well. FIGS. 3 and 3A will now be described in conjunction with one another.

It is first assumed that user 106 provides inputs to system 100 so that visualization component 114 generates a workspace display 128, for a given workspace. In one embodiment, the user can simply actuate one of the workspace display cards or list items on dashboard 126. This is indicated by block 350 shown in FIG. 3. In response, visualization component 114 displays the workspace display 128 corresponding to the actuated workspace display card or list item. This is indicated by block 352 in FIG. 3.

FIG. 3A shows one embodiment of this. It is assumed that the user has actuated the workspace display card 240 shown in FIG. 2G, such as by tapping it, or clicking it, or otherwise. In response, visualization component 114 generates the corresponding workspace display 128, for the workspace represented by card 240. In the embodiment discussed herein, the particular workspace is for the “Finance Period End” workspace. Workspace display 128 illustratively includes a display card section 354, along with a chart section 356, a list section 358, and an entity display section 360.

Section 354 illustratively shows the information that is displayed on the corresponding display card 240 on the dashboard display 126. In the embodiment shown in FIG. 3A, section 356 is a chart display section that displays various charts 362 and 364 that have been selected by user 106 to appear in section 356. Section 358 is a list display showing a set of tasks corresponding to the workspace, and entity display section 360 illustratively displays user interface elements 366, 368 and 370 that represent underlying data entities, that have been selected by user 106 to appear in section 360 on workspace display 128. In one embodiment, elements 366-370 are active tiles which dynamically display information from an underlying entity. It can also be seen that, in one embodiment, workspace display 128 is a panoramic (e.g., horizontally scrollable) display that is scrollable in the directions indicated by arrow 174.

Once the workspace display 128 is displayed, the user can illustratively customize the information that appears on the corresponding display card 240 on dashboard display 126, by choosing the items that appear in section 354 on workspace display 128. In one example, the user can simply move items from sections 356, 358 and 360 into section 354, and position them within section 354 as desired. In response, customization component 116 customizes the corresponding workspace display card 240 so that it shows the information placed on section 354 by user 106.

By way of example, user 106 can illustratively select tile 370 (indicated by the dashed line around tile 370) and move it to a desired position in section 354, as indicated by arrow 372. This can be done using a drag and drop operation, or a wide variety of other user inputs as well. Once the user has done this, when the user returns to dashboard display 126, tile 370 will appear on the corresponding card 240, as shown in section 354.

The user can illustratively remove items from card 240 by again going to the workspace display 128 and removing those items from section 354, and placing them back in one of the other sections 356-360, or by simply deleting them, in which case they will no longer appear on workspace 128 or card 240. In addition, user 106 can place other items on the corresponding workspace display card 240 by moving them from the corresponding sections 356-360, into section 354. They will appear on card 240, where the user places them in section 354, when the user navigates back to dashboard display 126.

Returning again to the flow diagram of FIG. 3, receiving a user input identifying a selected display item on workspace display 128 that is to be included on the corresponding card on the dashboard display 126 is indicated by block 380. Touching or clicking and holding the item to select it is indicated by block 382, using a drag and drop operation to a predetermined location on workspace display 128 is indicated by block 384, and identifying the selected display item in other ways is indicated by block 386.

The present discussion has mentioned processors and/or servers. In one embodiment, the processors and servers include computer processors with associated memory and timing circuitry, not separately shown. They are functional parts of the systems or devices to which they belong and are activated by, and facilitate the functionality of, the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

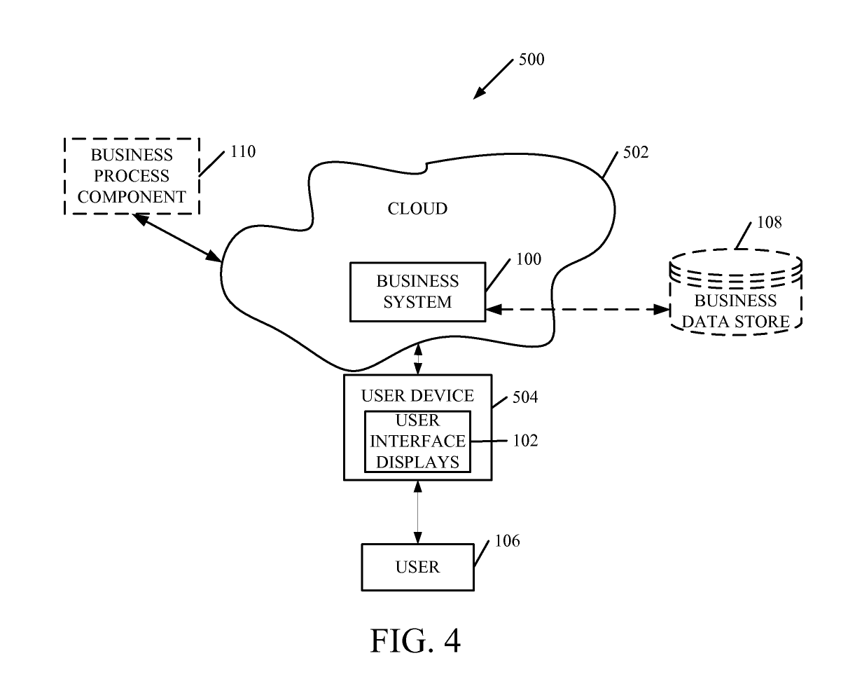

FIG. 4 is a block diagram of business system 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of system 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 4, some items are similar to those shown in FIG. 1 and they are similarly numbered. FIG. 4 specifically shows that system 100 is located in cloud 502 (which can be public, private, or a combination where portions are public while others are private). Therefore, user 106 uses user device 504 to access system 100 through cloud 502.

FIG. 4 also depicts another embodiment of a cloud architecture. FIG. 4 shows that it is also contemplated that some elements of system 100 are disposed in cloud 502 while others are not. By way of example, data store 108 can be disposed outside of cloud 502, and accessed through cloud 502. In another embodiment, business process component 110 is also outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that system 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

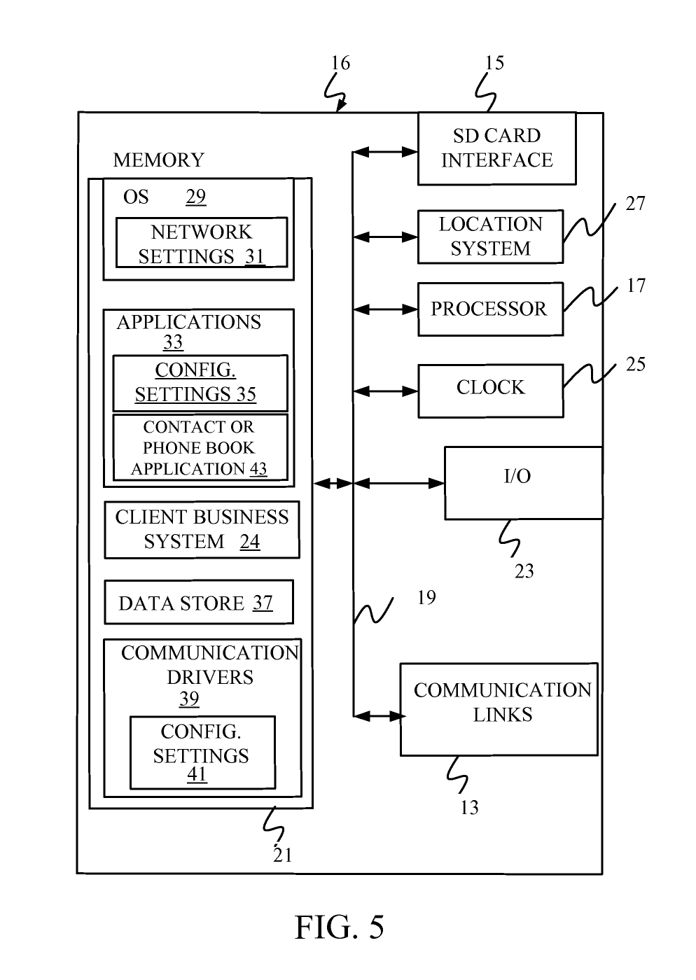

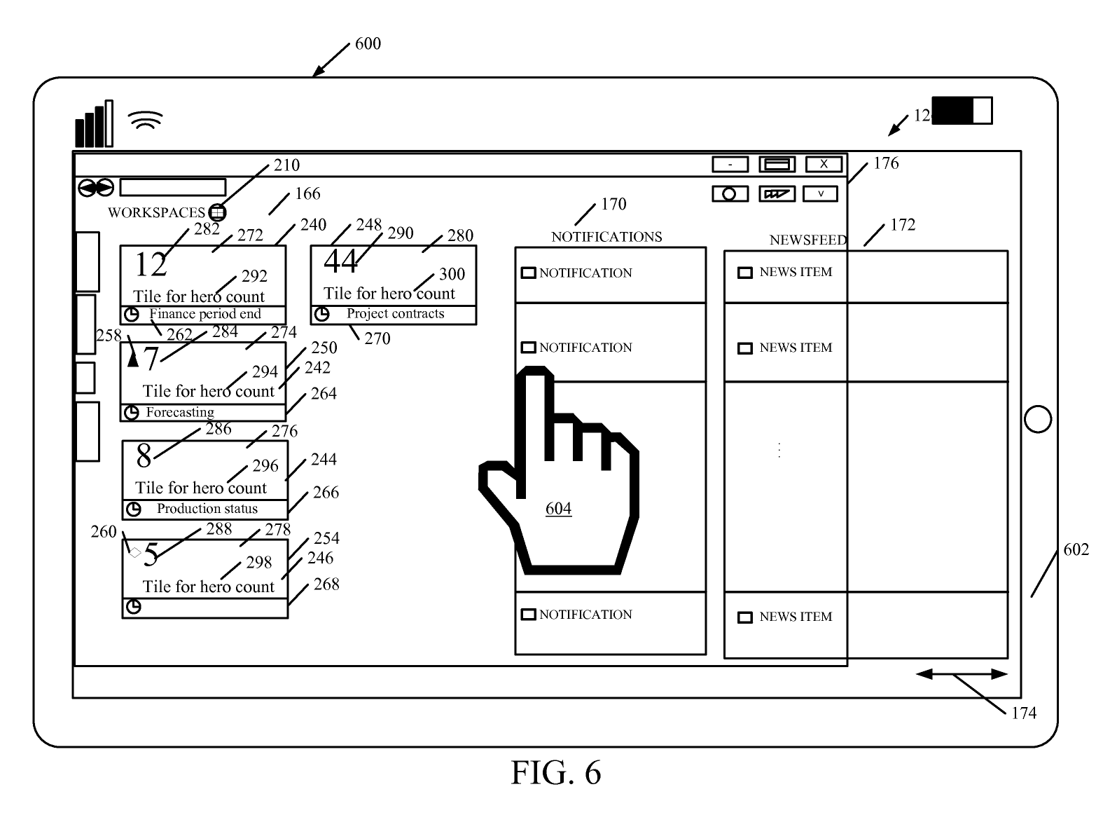

FIG. 5 is a simplified block diagram of one illustrative embodiment of a handheld or mobile computing device that can be used as a user's or client's hand held device 16, in which the present system (or parts of it) can be deployed, or which can comprise user device 504. FIGS. 6-10 are examples of handheld or mobile devices.

FIG. 5 provides a general block diagram of the components of a client device 16 that can run components of system 100 or that interacts with system 100, or both. In the device 16, a communications link 13 is provided that allows the handheld device to communicate with other computing devices and under some embodiments provides a channel for receiving information automatically, such as by scanning Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processor 112 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 6 shows one embodiment in which device 16 is a tablet computer 600. In FIG. 6, computer 600 is shown with user interface display from FIG. 2H shown on display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

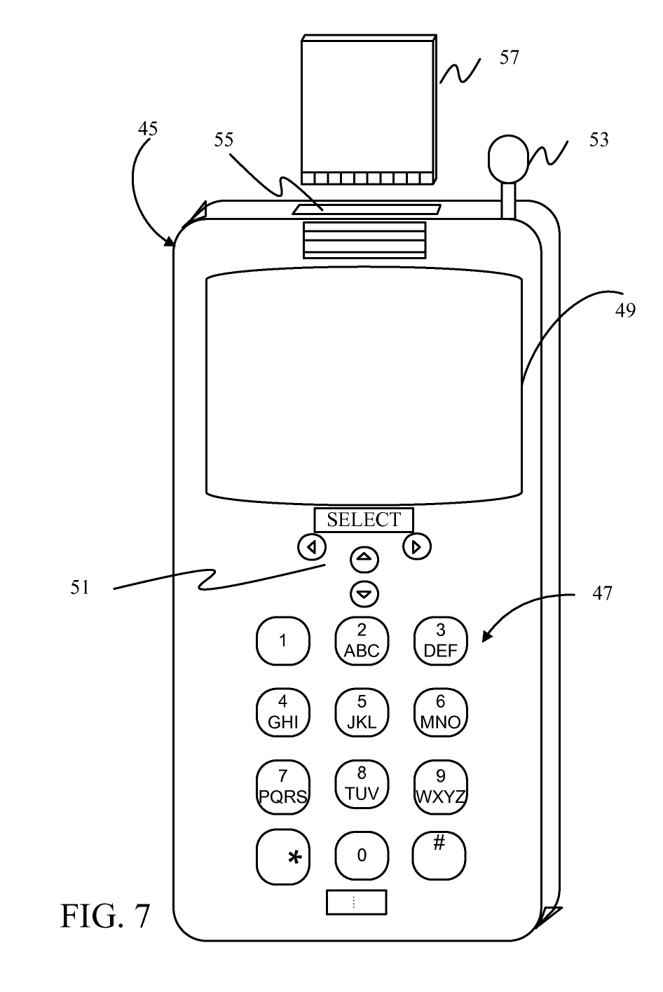

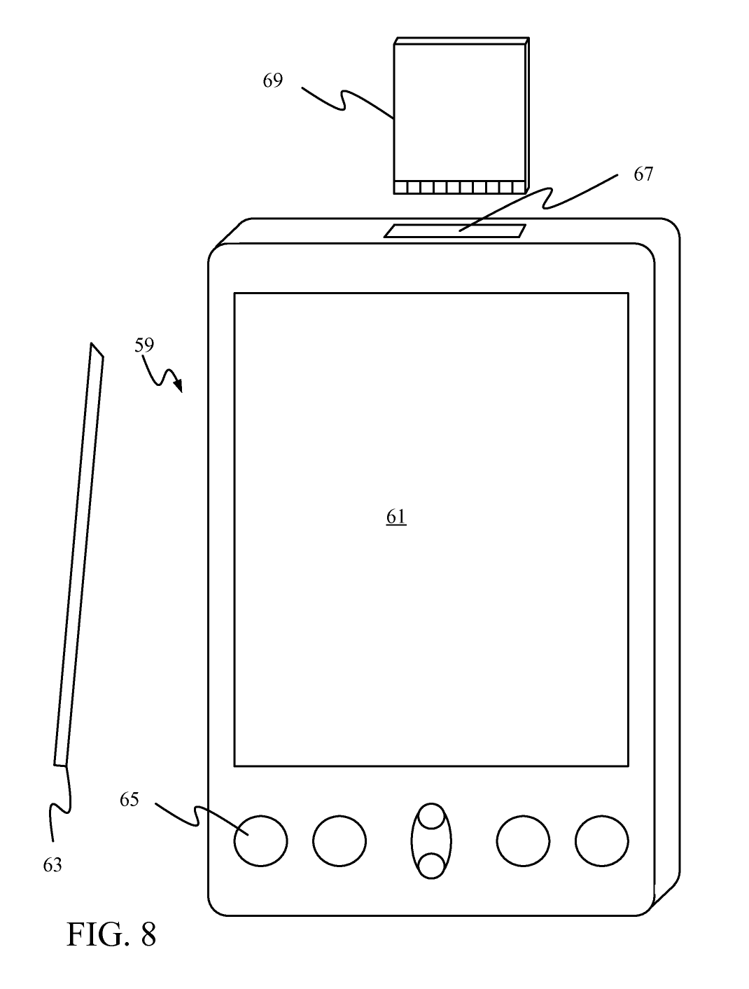

FIGS. 7 and 8 provide additional examples of devices 16 that can be used, although others can be used as well. In FIG. 7, a feature phone, smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 8 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

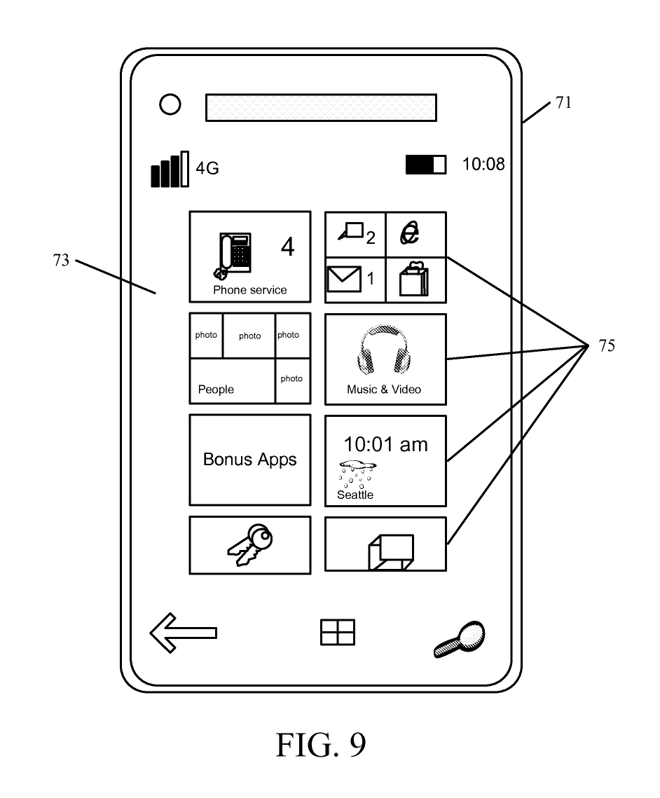

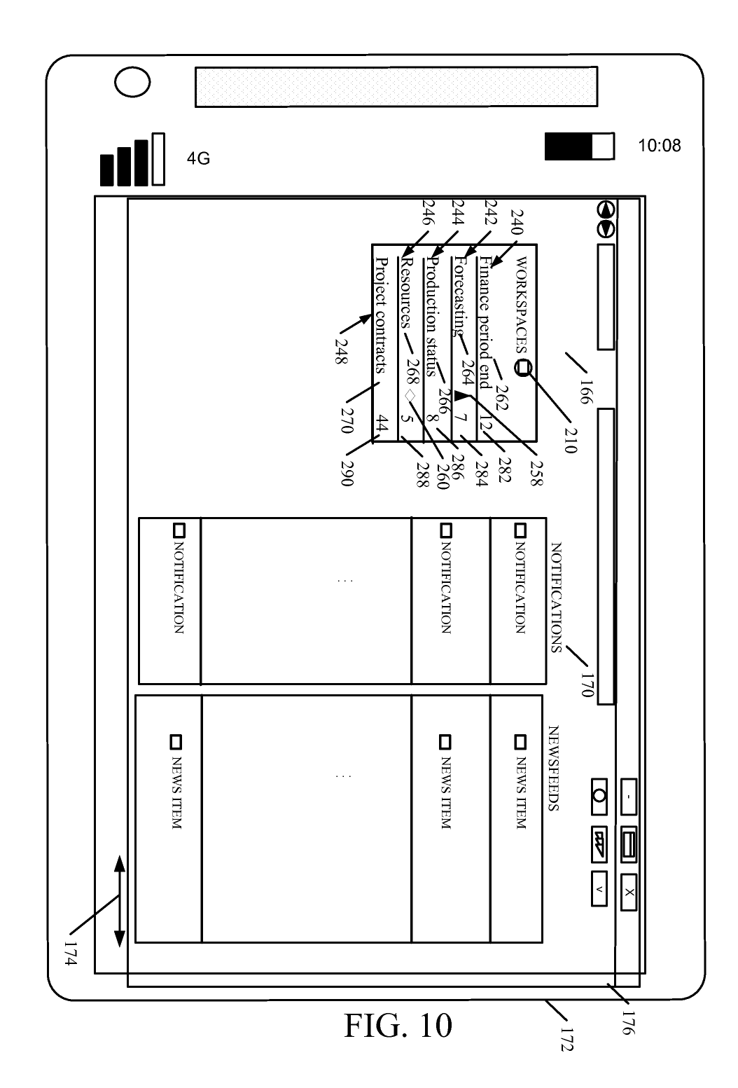

FIG. 9 is similar to FIG. 7 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone. FIG. 10 shows phone 7 with the display of FIG. 2I displayed thereon.

Note that other forms of the devices 16 are possible.

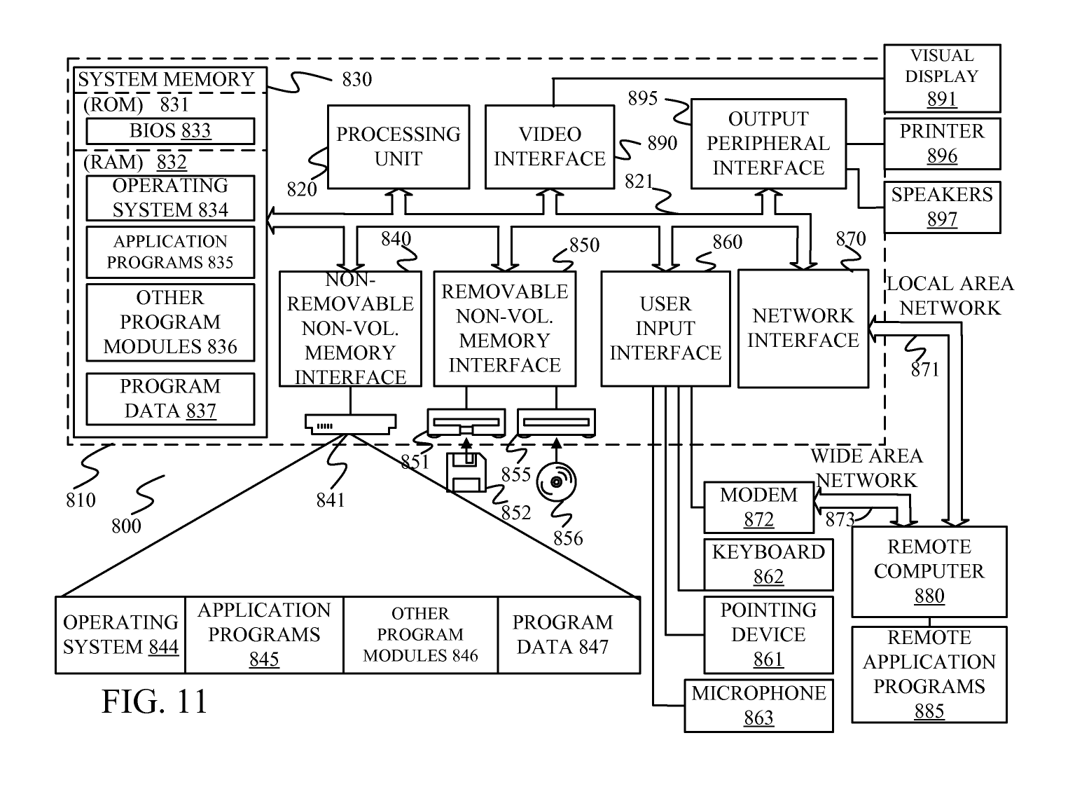

FIG. 11 is one embodiment of a computing environment in which system 100, or parts of it, (for example) can be deployed. With reference to FIG. 11, an exemplary system for implementing some embodiments includes a general-purpose computing device in the form of a computer 810. Components of computer 810 may include, but are not limited to, a processing unit 820 (which can comprise processor 112), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 11.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 11 illustrates operating system 834, application programs 835, other program modules 836, and program data 837.

The computer 810 may also include other removable/non-removable volatile/nonvolatile computer storage media. By way of example only, FIG. 11 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 11, provide storage of computer readable instructions, data structures, program modules and other data for the computer 810. In FIG. 11, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 11 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 11 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claim.

What is claimed is:

1. A computer-implemented method, comprising:
generating a panoramic dashboard display on a visual display device, with a plurality of display sections corresponding to a user that has a given role in a computer system, the display sections including a customer-branded section that displays customer-specific information, a favorites section that displays user-selectable favorite display elements each linked to a place in the computer system, a workspace display section that displays a plurality of workspace display elements each linked to a workspace display that displays information from a workspace in the computer system corresponding to the given role, and a live data feed section that displays data feed display elements that are linked to underlying data;
receiving a user interaction with the dashboard display; and
performing a user interface display action based on the user interaction.

2. The computer-implemented method of claim 1 wherein the computer system comprises a business system, and wherein generating the panoramic dashboard display comprises:
displaying the user-selectable favorite display elements, each linked to a place in the business system.

3. The computer-implemented method of claim 2 wherein generating the panoramic dashboard display comprises:
displaying the workspace display elements, each linked to workspace display that displays business information from a business workspace in the business system.

4. The computer-implemented method of claim 3 wherein generating the panoramic dashboard display comprises:
displaying the data feed display elements that are linked to underlying business data.

5. The computer-implemented method of claim 4 wherein displaying the customer-branded section includes displaying user-specific information.

6. The computer-implemented method of claim 4 and further comprising:
prior to generating the panoramic dashboard display, receiving a user input requesting access to the panoramic dashboard display; and
loading data into the panoramic dashboard display.

7. The computer-implemented method of claim 6 wherein generating the panoramic dashboard display comprises:
initially displaying the customer-branded section; and
after initially displaying the customer-branded section, visually moving the customer-branded section off of the visual display device to display the workspace display section, as data is loaded into the panoramic dashboard display.

8. The computer-implemented method of claim 7 wherein visually moving the customer-branded section to display the workspace display section, comprises:
landing on the workspace display section as a first, fully-viewable display section displayed to the user after the panoramic dashboard display is fully loaded with data.

9. The computer-implemented method of claim 4 wherein generating the panoramic dashboard display comprises:
displaying the customer-branded section, the favorites section, the workspace display section, and the live data feed section in order from left to right on the panoramic dashboard display.

10. The computer-implemented method of claim 4 wherein displaying the live data feed section comprises:
displaying a notifications feed section that displays a plurality of notification display elements, each linked to a notification.

11. The computer-implemented method of claim 10 wherein displaying the live data feed section comprises:
displaying a news feed section that displays a plurality of news display elements, each linked to a news item.

12. The computer-implemented method of claim 4 wherein displaying the favorites display elements comprises:
displaying a dynamic display element including a visual indicator indicative of underlying data, the visual indicator being updated as the underlying data is updated.

13. The computer-implemented method of claim 4 wherein displaying the workspace display elements comprise:
displaying a dynamic display element including a visual indicator indicative of underlying data, the visual indicator being updated as the underlying data is updated.

14. A computer system, comprising:
a process component that runs processes in the computer system and that generates user interface displays with user input mechanisms that receive user inputs to perform tasks within the computer system;
a visualization component that generates a dashboard display on a visual display device, with a plurality of display sections corresponding to a user that has a given role in a computer system, the display sections including a customer-branded section that displays customer-specific information, a favorites section that displays user-selectable favorite display elements each linked to a place in the computer system, a workspace display section that displays a plurality of workspace display elements each linked to a workspace display that displays information from a workspace in the computer system corresponding to the given role, and a live data feed section that displays data feed display elements that are linked to underlying data; and
a computer processor that is a functional part of the computer system and activated by the process component and the visualization component to facilitate running the processes and generating the dashboard display.

15. The computer system 14 wherein the process component runs business processes in the computer system and wherein the display sections each display business data.

16. A computer readable storage medium storing computer executable instructions which, when executed by a computer, cause the computer to perform a method, comprising:
generating a panoramic dashboard display on a visual display device, with a plurality of display sections corresponding to a user that has a given role in a computer system, the display sections including dynamic display elements that display visual indicia that is updated as underlying data is updated, the display sections including a customer-branded section that displays customer-specific information, a favorites section that displays user-selectable, dynamic favorite display elements each linked to a place in the computer system, a workspace display section that displays a plurality of dynamic workspace display elements each linked to a workspace display that displays information from a workspace in the computer system corresponding to the given role, and a live data feed section that displays dynamic data feed display elements that are linked to underlying data;
receiving a user interaction with the dashboard display; and
performing a user interface display action based on the user interaction.

17. The computer readable storage medium of claim 16 wherein the computer system comprises a business system, and wherein generating the panoramic dashboard display comprises:
displaying the user-selectable favorite display elements, each linked to a place in the business system;
displaying the workspace display elements, each linked to workspace display that displays business information from a business workspace in the business system; and
displaying the data feed display elements that are linked to underlying business data.

18. The computer readable storage medium of claim 17 and further comprising:
prior to generating the panoramic dashboard display, receiving an input requesting access to the panoramic dashboard display; and
loading data into the panoramic dashboard display.

19. The computer readable storage medium of claim 18 wherein generating the panoramic dashboard display comprises:
initially displaying the customer-branded section; and
after initially displaying the customer-branded section, visually moving the customer-branded section off of the visual display device to display the workspace display section, as data is loaded into the panoramic dashboard display.

20. The computer readable storage medium of claim 17 wherein generating the panoramic dashboard display comprises:
displaying the customer-branded section, the favorites section, the workspace display section, and the live data feed section in order from left to right on the panoramic dashboard display.
